(19) United States
(12) Patent Application Publication
(10) Pub. No.: US 2013/0087671 A1
(43) Pub. Date: Apr. 11, 2013

(54) Selectively Positionable Apparatus Holder

(71) Applicants: Randel B. Homes, Knoxville, TN (US); Robert L. McClure, Elizabethton, TN (US); Brian Jenkins, Cummings, GA (US); Tracey Herald, Knoxville, TN (US)

(72) Inventors: Randel B. Homes, Knoxville, TN (US); Robert L. McClure, Elizabethton, TN (US); Brian Jenkins, Cummings, GA (US); Tracey Herald, Knoxville, TN (US)

(73) Assignee: Alleset, Inc., Flowery Branch, GA (US)

(21) Appl. No.: 13/269,873

(22) Filed: Oct. 10, 2011

(51) Int. Cl. F16M 13/00; A44B 18/00; F16B 47/00

(52) U.S. Cl. 248/309.1

(57) ABSTRACT

The Selectively Positionable Apparatus Holder is an apparatus holder which may be selectively positioned and fixedly attached to a material such as, for example, a surgical drape, table cover, or equipment cover. The selectively positionable apparatus holder, in some of its various embodiments, comprises a base having a dorsal side and a ventral side with the ventral side being fixedly attachable to a surface, at least one strap integrally formed with the base, the at least one strap having a dorsal side, a ventral side, a proximal end to the base and a distal end projecting outward from the base, the at least one strap further including a means of releasably joining unto itself, whereby the selectively positionable apparatus holder may be selectively positioned upon a material to provide for releasably securing an apparatus.

### CROSS-REFERENCE TO RELATED APPLICATIONS

Not Applicable.

### STATEMENT REGARDING FEDERALLY-SPONSORED RESEARCH OR DEVELOPMENT

Not Applicable.

### BACKGROUND OF THE INVENTION

1. Field of Invention

The present general inventive concept relates generally to surgical apparatus holders, and, more particularly, to a selectively positionable apparatus holder for use on surgical drapes.

2. Description of the Related Art

During many medical procedures, including surgical procedures, it is necessary to utilize various tubes, lines, cables, cords or similar elongated, substantially cylindrical conduit-type medical apparatus. Tubes may be used either to provide fluids into a patient, or alternatively, remove fluid or fluids from a patient. Lines and/or cords may be used in such medical apparatus as heart monitors, electrosurgical cautery pencils, and the like. Such elongated, substantially cylindrical conduit-type medical apparatus are utilized in veterinary medicine, as well as human medicine. Precision placement of such conduit may be critical, for several reasons. First, such conduit are typically flexible, thus it is vital that no impedance occur by twisting, over-bending, or kinking the conduit. Further, often such conduit are utilized in multiple and/or complex arrangements, thus it is important to maintain the integrity of each individual tube or similar conduit. In addition, such conduit are often used in medical procedures; such procedures may include other medical materials that have the potential to cut (e.g., scalpels, electrosurgical cautery pencils, lasers, etc.) these conduit, materials that have the potential to bind (e.g., bandaging, tape, etc.) these conduit, and other materials that may sever or crush these conduit unless the conduit are positioned carefully so as to eliminate or reduce the risk of damage to them. Once so positioned, maintaining both the safe and secure positioning of such conduit to protect them is also of vital importance.

Known prior art in this field includes apparatus holders that, typically, are pre-attached and pre-positioned to such medical materials as surgical drapes. In general, standard holders are permanently affixed to the medical material in a prearranged position during manufacture of the surgical drape or other medical material. This prearranged position is usually in the center of the surgical drape, and usually oriented in a concentric manner so as to align with the parameters of the drape. Typically, the holders include hook-and-loop closure tabs to wrap around the apparatus, position the apparatus, and keep the apparatus in place until such time as the apparatus needs to be removed.

Most medical materials that include a standard holder, however, provide only one such holder, and, as discussed above, in a fixed, predetermined position. Because of this, any number of negative results relative to the conduit may occur. These negative results may include, but are not limited to, undue stress of the hook-and-loop closures such that the conduit is inadvertently released, limited options of specific orientation of the conduit, and/or insufficient points of capture of the conduit such that non-secured portions of the conduit move too freely and either bend, bind, become entangled, or inadvertently stray into the path of a clamp or other medical instrument or product such that the conduit is damaged. Further, such standard holders preclude ready attachment of additional holders during a procedure.

Both the safety and efficiency of any such conduit would be greatly enhanced if an apparatus holder could be placed anywhere upon a surgical drape or other medical material. Known prior art does not teach a selectively positionable apparatus holder in accord with the present general inventive concept. A holder that is selectively positionable would enable medical personnel to place a holder in a specific location, thereby allowing the conduit to be held by the holder at the precise location desired and eliminate or reduce any possibility of risk to the conduit. Additionally, a holder that is selectively positionable allows specific orientation of the holder, irrespective of the surface to which the holder is affixed. This provides for specific orientation of the conduit to eliminate or reduce any possibility of risk to the conduit. Also, a selectively positionable apparatus holder provides the option of affixing more than one such selectively positionable apparatus holder on any given surgical drape or other medical material. Utilization of multiple such selectively positionable apparatus holders would provide additional points to secure conduit or a plurality of conduits, as well as options to specifically orient the conduit or outline its position upon the drape. Also, selectively positionable apparatus holders may be used to secure various types of conduit either in bundles or separately, as circumstances may require. In addition, selectively positional apparatus holders may be placed strategically upon surgical drapes to best conform with the dimensions of the area being covered by the drape. Additionally, a selectively positionable apparatus holder provides a cost-effective means for use of such holders over holders integrated into surgical drapes.

### BRIEF SUMMARY OF THE INVENTION

The present general inventive concept, a selectively positionable apparatus holder, in some of its various embodiments, comprises a base having a dorsal side and a ventral side with the ventral side being fixedly attachable to a surface, at least one strap integrally formed with the base, the at least one strap having a dorsal side, a ventral side, a proximal end to the base and a distal end projecting outward from the base, the at least one strap further including a means of releasably joining upon itself whereby the selectively positionable apparatus holder may be selectively positioned upon a material to provide for releasably securing an apparatus to a material. In some embodiments, the means for releasably joining the at least one strap upon itself is a section of hook and loop closure material. In some embodiments, the ventral side of the base is fixedly attached to a surface by means of an adhesive coating, known in the art, affixed upon the ventral side of the base. In some embodiments, a hi-tack adhesive is utilized to enhance the stability of the selectively positionable apparatus holder once it is in place. In some embodiments, the selectively positionable apparatus holder can be affixed to various types of material, including non-woven, woven, and film materials. In some embodiments, a removable adhesive protective layer is provided to protect the adhesive affixed to the ventral side of the base until such time as a user removes the removable adhesive protective layer in order to expose the adhesive for selectively positioning and affixing the apparatus holder to a surgical drape or similar medical material.

Ideally, the base and strap(s) are constructed of a strong, flexible, moisture resistant material. In some embodiments, the base and strap(s) are constructed out of a high-density polyethylene material, such as Tyvek®. Such high-density polyethylene material provides sufficient strength and flexibility to allow the base and strap(s) to be selectively positioned and remain securely intact once positioned, irrespective of the normal material stresses associated with surgical procedures, such as contact with or saturation by fluids.

The at least one strap has a dorsal side and ventral side, a proximal end being integrally formed with the base, and a distal end projecting away from the base, and a means of releasably joining upon itself. In some embodiments, the at least one strap's means of releasably joining upon itself is at least one strip of loop material and at least one strip of hook material affixed to the dorsal side of each strap. In some embodiments, the at least one strip of loop material and at least one strip of hook material is affixed to the dorsal side of each strap via adhesive, known in the art. In some embodiments, the at least one strip of loop material is affixed to the dorsal side of each strap near the proximal end of the strap. In some embodiments, the at least one strip of hook material is affixed to the dorsal side of each strap near the distal end of the strap. In some embodiments, low profile loop material and low profile hook material is utilized. In some embodiments, a first plain section of strap projects outward from the base, followed by loop material affixed to the dorsal side of the strap, followed by a second plain section of strap, followed by hook material affixed to the dorsal side of the strap, with the strap terminating in a third plain section. This terminal third plain section of the strap acts as a tab, by which the strap may be manipulated. In some embodiments of the present general inventive concept, the base is partially affixed and contains a slot through which the at least one strap can be passed through. In embodiments like this, the dorsal side of the base and the at least one strap can be releasably attachable to each other by, for example, inclusion of hook and loop material.

The strap may be manipulated in several ways. A user may grasp the strap tab and bend the strap to wrap it around conduit in order to secure the conduit. In some embodiments, the apparatus then lies within the second plain section of the strap, thereby resting upon a relatively smooth, nonabrasive section of the strap. The hook material is then placed in surface contact with the loop material and sufficient pressure is applied to cause the hook material to releasably enmesh with the loop material. The releasable enmeshment of the hook material with the loop material secures the apparatus within the encircled confines of the strap. To release the apparatus, the tab may be raised and the strap pulled, thus providing sufficient release pressure on the hook material to unenmesh it from the loop material, thus unencircling the strap from around the apparatus and releasing the apparatus. Further, the base can, in some embodiments, contain a slot through which the at least one strap can be inserted and passed through, to be releasably attached to the dorsal side of the base.

In some embodiments, the base has more than one strap integrally formed with and projecting from the base. In these embodiments, the plurality of straps may be utilized as described above to secure multiple apparatus. Alternatively, in these embodiments, the plurality of straps may be utilized in an interchangeable way, such that the straps would cross and the hook material of one strap may be enmeshed with the loop material of another strap. This “crossed” or “X” configuration of straps allows alternative securement of an apparatus or plurality of apparatus.

### BRIEF DESCRIPTION OF THE DRAWINGS

The above-mentioned and additional features of the present general inventive concept will become more clearly understood from the following detailed description of the present general inventive concept read together with the drawings in which:

FIG. 1A illustrates one embodiment of the present general inventive concept with one strap.

FIG. 1B illustrates another embodiment of the present general inventive concept with a compact base.

FIG. 2 illustrates another embodiment of the present general inventive concept with two straps.

FIGS. 3A and 3B illustrate various embodiments of the present general inventive concept in use on a surgical drape or other medical material.

FIG. 4 illustrates another embodiment of the present general inventive concept with two straps utilized in a crossing or “X” pattern.

FIG. 5 illustrates another embodiment of the present general inventive concept with a slot in the base.

FIG. 6 illustrates another embodiment of the present general inventive concept with a slot in the base and partial adhesive.

FIG. 7 illustrates another embodiment of the present general inventive concept with one strap inserted through a slot in the base.

### DETAILED DESCRIPTION OF THE INVENTION

The present general inventive concept, in some of its embodiments, comprises a Selectively Positionable Apparatus Holder, an apparatus holder which may be selectively positioned and fixedly attached to a material such as, for one example, a surgical drape. The selectively positionable apparatus holder, in some of its various embodiments, comprises a base having a dorsal side and a ventral side with the ventral side being fixedly attachable to a surface, at least one strap integrally formed with the base, the at least one strap having a dorsal side, a ventral side, a proximal end to the base and a distal end projecting outward from the base, the at least one strap further including a means of releasably joining upon itself whereby the selectively positionable apparatus holder may be selectively positioned upon a material to provide for releasably securing an apparatus.

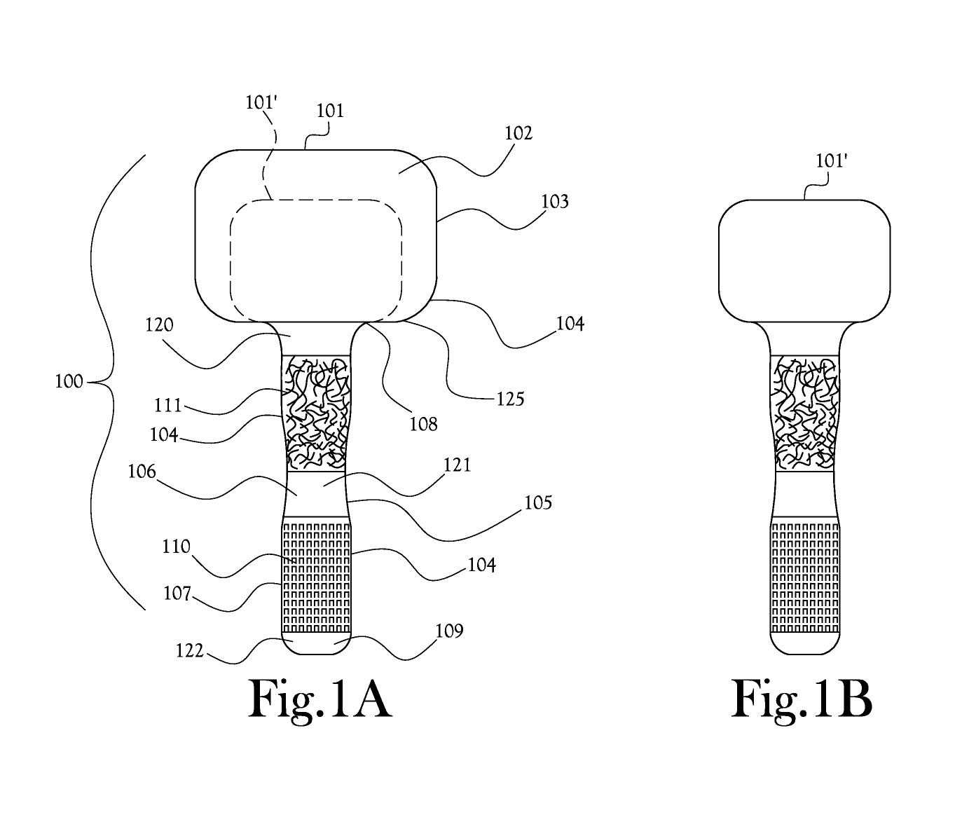

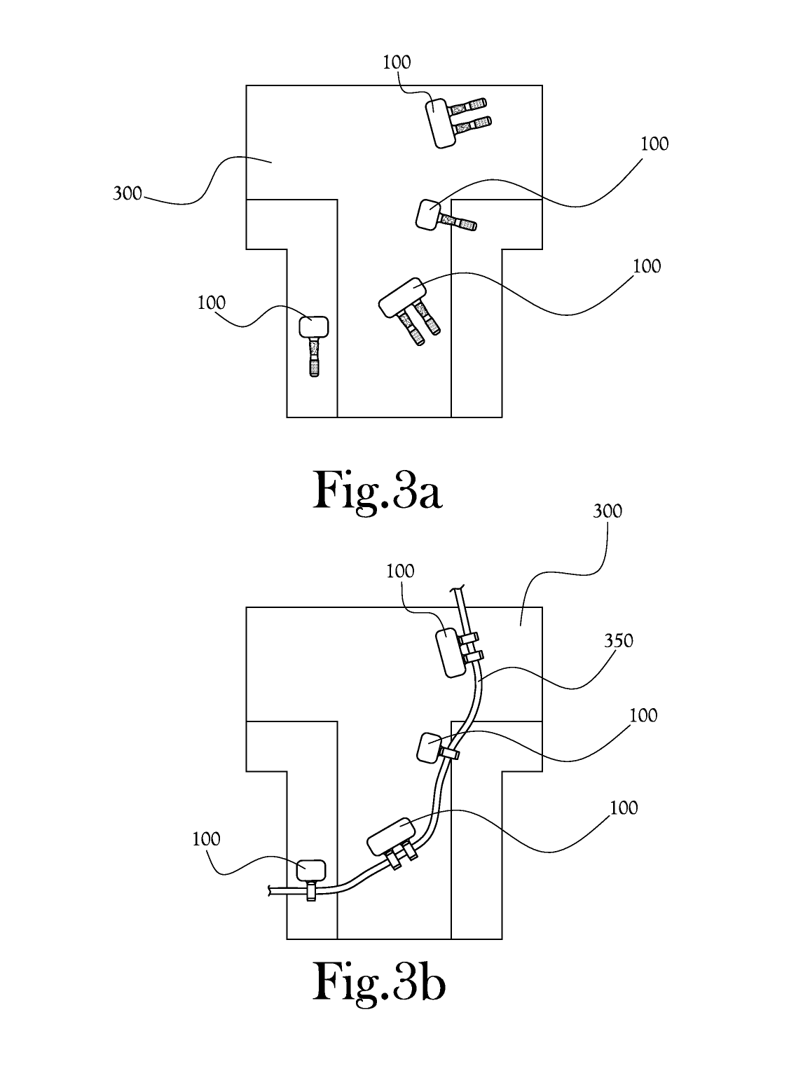

FIG. 1A illustrates an example, or one embodiment, of the present general inventive concept, this embodiment illustrating one strap. The present general inventive concept 100 includes base 101 integrally formed with at least one strap 105. Also illustrated in FIG. 1A is base 101′—an alternate, more compact version of base 101 which contains identical parts as base 101 and functions exactly the same as base 101, described herein in detail. (see also FIG. 1B). Base 101 has a dorsal side 102 and a ventral side 103. In similar fashion, at least one strap 105 has a dorsal side 106 and a ventral side 107. The at least one strap 105 additionally has a proximal end 108 and a distal end 109. The at least one strap 105 is integrally formed to base 101 at proximal end 108, with the distal end 109 of at least one strap 105 projecting away from base 101. Once present general inventive concept 100 is selectively positioned, ventral side 103 of base 101 is fixedly attached to a surface 300 (see FIG. 3). In some embodiments, adhesive coating 104 is placed upon ventral side 103, thereby providing fixedly attachable means to ventral side 103. If adhesive coating 104 is thus placed upon ventral side 103, removeable adhesive protection cover 125 is removeably attached to adhesive coating 104 to protect adhesive coating 104 until such time as adhesive coating 104 is exposed by removing the removeable adhesive protection cover 125 to fixedly attach ventral side 103 of base 101 to a surface 300 such as surgical drape or other material.

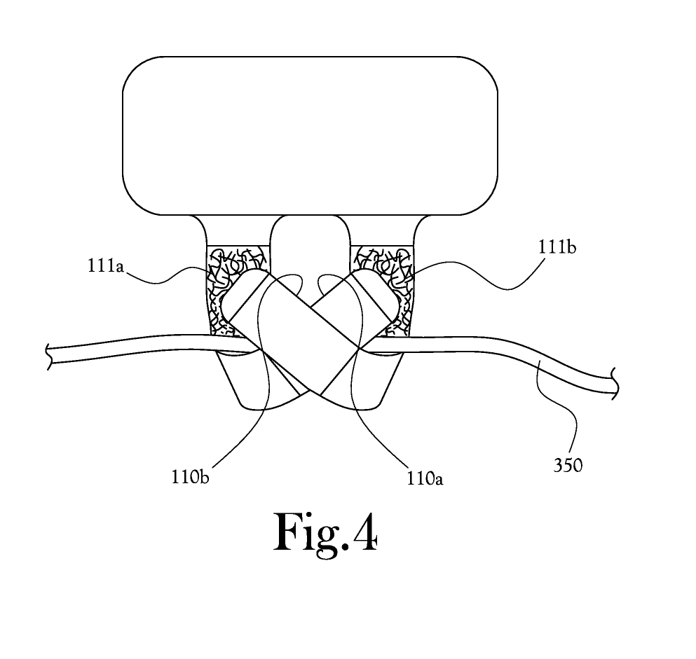

As also illustrated in FIG. 1A, in some embodiments, the at least one strap 105 further has at least one strip of loop material 111 and at least one strip of hook material 110 attached upon the dorsal side 106 of the at least one strap 105 to provide a means for the at least one strap 105 to releasably join upon itself. In some embodiments, adhesive coating 104 is utilized to affix the at least one strip of loop material 111 and the at least one strip of hook material 110 to the dorsal side 106 of the at least one strap 105. A conduit 350, such as, but not limited to, a tube, line or cord, (see FIGS. 3A, 3B and 4) is placed on the dorsal side 106 of strap 105. The at least one strip of hook material 110 is placed in surface contact with the at least one strip of loop material 111 and sufficient pressure is applied to cause the at least one strip of hook material 110 to releasably enmesh with the at least one strip of loop material 111, thereby securing the conduit 350 (see FIGS. 3A, 3B and 4). To release the conduit 350, sufficient release pressure (e.g., pulling) is placed upon the at least one strap 105 so as to release the at least one strap 105 by, in some embodiments, unenmeshing the strips of hook material 110 from the strips of loop material 111, thereby facilitating removal of the conduit 350.

Additionally, and also illustrated in FIG. 1A, in some embodiments, the at least one strap 105 is defined to include a first plain section 120, located at the proximate end 108 of strap 105. In some embodiments, at least one strip of loop material 111 is next affixed to the dorsal side 106 of the at least one strap 105. A first plain section 120 provides space for the at least one strap 105 to flex and bend, relative to its proximate end 108 which is integrally formed with base 102, as base 102, once selectively positioned and fixedly attached to a surface, becomes relatively immobile. Following the at least one strip of loop material 111, a second plain section 121 of the at least one strap 105 is provided. Second plain section 121 of the at least one strap 105 enhances the flexibility of the at least one strap 105, and, additionally, provides a smooth surface on the dorsal side 106 of the at least one strap 105, on which a conduit 350 may be placed with minimal risk of abrasion. Moving from the proximal end 108 of the at least one strap 105 towards the distal end 109 of the at least one strap 105, at least one strip of hook material 110 is affixed to the dorsal side 106 of the at least one strap 105. In some embodiments, the placement of the at least one strip of loop material 111 and the at least one strip of hook material 110 may be interchanged. In some embodiments, the distal end 109 of the at least one strap 105 is a third plain section 122, which functions as a tab for ease of manipulating the at least one strap 105, including, but not limited to, both enmeshing and unenmeshing the at least one strip of hook material 110 from the at least one strip of loop material 111.

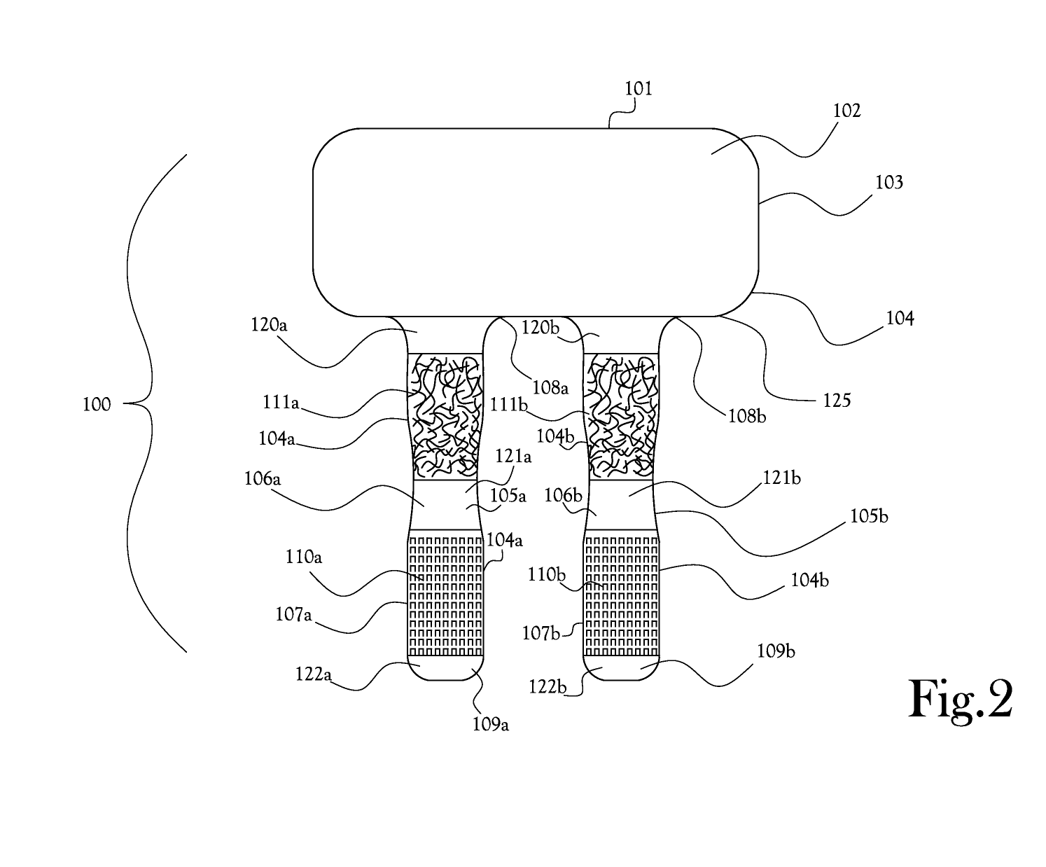

FIG. 2 illustrates another example of the present general inventive concept, this embodiment illustrating a plurality of strap 105. Identical parts function in identical fashion as described above, irrespective of whether an embodiment contains one or a plurality of strap 105. Thus, in this embodiment, base 101 is defined to have two strap 105a and 105b integrally formed with base 101 at proximal ends 108a and 108b. In the illustrated embodiment, straps 105a and 105b are shown to have dorsal side 106a and 106b and ventral side 107a and 107b, respectively. Additionally, and optionally, straps 105a and 105b, as shown, reflect first plain sections 120a and 120b to provide flexibility to straps 105a and 105b. Moving down straps 105a and 105b from proximal ends 108a and 108b, respectively, towards distal ends 109a and 109b, strips of loop material 111a and 111b are attached to dorsal side 106a and 106b, respectively. In some embodiments, adhesive coating 104 is utilized to affix strips of loop material 111a and 111b to dorsal sides 106a and 106b. At the approximate midpoint of straps 105a and 105b may be, optionally, a second plain section 121a and 121b, whereby to create a smooth or nonabrasive surface upon which a conduit 350 may be placed with minimal risk of harm. Next, strips of hook material 110a and 110b are attached to dorsal side 106a and 106b, respectively. In some embodiments, adhesive coating 104 is utilized to affix strips of hook material 110a and 110b to dorsal sides 106a and 106b. At the distal ends 109a and 109b of straps 105a and 105b, respectively, may be, optionally, a third plain section 122a and 122b, which may serve as a tab to assist a user with manipulation of straps 105a and 105b.

In like manner as described above, each of straps 105a and 105b are manipulated so as to encompass a conduit 350 (see FIGS. 3A, 3B and 4). In some embodiments, the respective strips of hook material 110a and 110b are placed in surface contact with strips of loop material 111a and 111b, and then sufficient pressure is placed upon respective strips of hook material 110a and 110b and strips of loop material 111a and 111b to cause releasable enmeshment to occur between the respective strips of hook material 110a and 110b and strips of loop material 111a and 111b thereby releasably joining 105a to itself and 105b to itself, thus securing the conduit 350. To release the conduit 350, sufficient release pressure (e.g., pulling) is placed upon straps 105a and 105b so as to release straps 105a and 105b by, in some embodiments, unenmeshing the strips of hook material 110a and 110b from the strips of loop material 111a and 111b, thereby facilitating removal of the conduit 350.

FIGS. 3A and 3B illustrates optional uses of the present general inventive concept whereby a plurality of the present general inventive concept are utilized in various selective positions on a surface 300.

FIG. 4 illustrates another embodiment of the present general inventive concept whereby an embodiment with two strap 105a and 105b are being utilized optionally in a cross or “X” configuration. In this optional configuration, straps 105a and 105b are manipulated to cross over one another as one manipulates straps 105a and 105b to secure a conduit 350. In this optional configuration, strip of hook material 106a is releasably enmeshed with strip of loop material 106b and strip of hook material 106b is releasably enmeshed with strip of loop material 106a. This optional configuration may be useful with smaller conduit or conduit that must be secured in a particular way. As with other possible embodiments, to release the conduit 350, sufficient release pressure (e.g., pulling) is placed upon straps 105a and 105b so as to unenmesh the strips of hook material 110a and 110b from the strips of loop material 111b and 111a, respectively, thereby facilitating removal of the conduit 350.

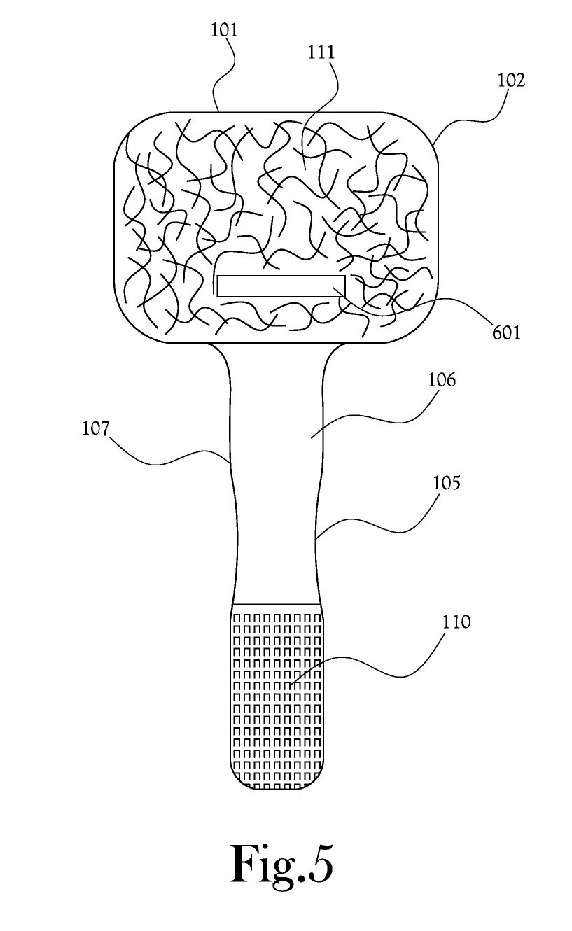

FIG. 5 illustrates another embodiment of the present general inventive concept whereby the base 101 has defined therethrough a slot 601. In some embodiments, dorsal side 102 of base 101 has affixed thereto a section of loop material. At least one strap 105, having a dorsal side 106 and a ventral side 107, can include a section of hook material 110 at the distal end of the at least one strap 105.

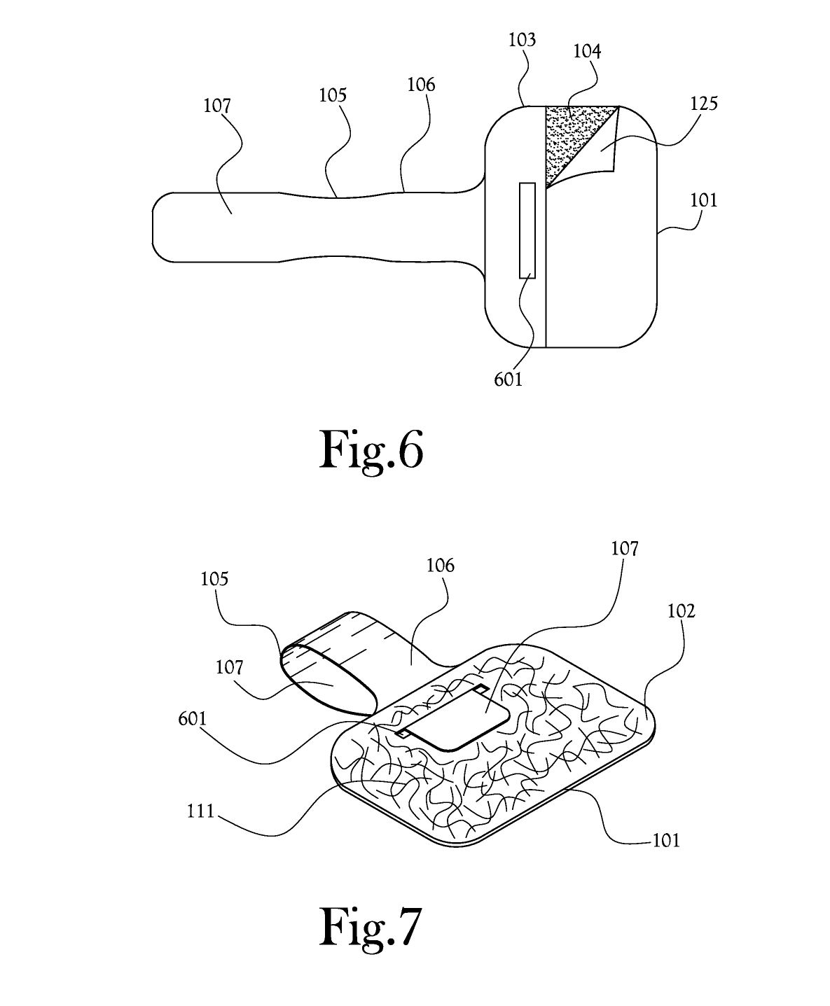

FIG. 6 illustrates an embodiment of the present general inventive concept including the ventral side 103 of base 101, showing slot 601. Adhesive 104 is attached to the majority of ventral side 103 and covered by removeable adhesive protection cover 125. The portion of ventral side 103 surrounding slot 601 has no adhesive, to allow insertion of the at least one strap 105 through slot 601.

FIG. 7 illustrates an embodiment of the present general inventive concept whereby at least one strap 105 can be inserted through slot 601. The hook material 110 (see FIG. 5) on the dorsal side 106 of strap 105 can be engaged via pressure onto the loop material 111 on dorsal side 102 of base 101, thus providing an alternative embodiment for use in appropriate circumstances.

While the present general inventive concept has been illustrated by description of some embodiments, and while the illustrative embodiments have been described in detail, it is not the intention of the applicant to restrict or in any way limit the scope of the appended claims to such detail. Additional modifications will readily appear to those skilled in the art. The present general inventive concept in its broader aspects is therefore not limited to the specific details, representative apparatus and methods, and illustrative examples shown and described. Accordingly, departures may be made from such details without departing from the spirit or scope of applicant's present general inventive concept.

1. A selectively positionable apparatus holder, comprising:
a base having a dorsal side and a ventral side, said ventral side being fixedly attachable to a surface;
at least one strap integrally formed with said base, said at least one strap having a dorsal side, a ventral side, a proximal end to said base and a distal end projecting outward from said base;
said at least one strap further having a means of releasably joining unto itself;
whereby said selectively positionable apparatus holder may be selectively positioned upon a material to provide for releasably securing an apparatus.

2. The selectively positionable apparatus holder of claim 1, further comprising an adhesive coating and a removeable adhesive protection cover, wherein said ventral side of said base is fixedly attachable to a surface by means of an adhesive coating upon said ventral side of said base and, further, said removeable adhesive protective cover is placed over said adhesive coating to protect said adhesive coating until such time as the base is fixedly attached to a material, whereby said selectively positionable apparatus holder may be selectively positioned upon a material to provide for releasably securing an apparatus to said material.

3. The selectively positionable apparatus holder of claim 1, said base and said at least one strap integrally formed with said base being constructed out of a high-density polyethylene material.

4. The selectively positionable apparatus holder of claim 2, said base and said at least one strap integrally formed with said base being constructed out of a high-density polyethylene material.

5. A selectively positionable apparatus holder, comprising:
a base having a dorsal side and a ventral side, said ventral side further including an adhesive coating whereby to be fixedly attachable to a surface;
at least one strap integrally formed with said base, said at least one strap having a dorsal side, a ventral side, a proximal end to said base and a distal end projecting outward from said base;
said at least one strap further having at least one strip of loop material and at least one strip of hook material attached upon said dorsal side of said at least one strap;
whereby said selectively positionable apparatus holder may be selectively positioned upon a material to provide for releasably securing an apparatus.

6. The selectively positionable apparatus holder of claim 5, further comprising an adhesive coating and a removeable adhesive protection cover, wherein said ventral side of said base is fixedly attachable to a surface by means of an adhesive coating upon said ventral side of said base and, further, said removeable adhesive protective cover is placed over said adhesive coating to protect said adhesive coating until such time as the base is fixedly attached to a material, whereby said selectively positionable apparatus holder may be selectively positioned upon a material to provide for releasably securing an apparatus to said material.

7. The selectively positionable apparatus holder of claim 5, wherein said at least one strip of loop material is attached upon said dorsal side of said at least one strap by means of an adhesive coating upon said dorsal side.

8. The selectively positionable apparatus holder of claim 6, wherein said at least one strip of hook material is attached upon said dorsal side of said at least one strap by means of an adhesive coating upon said dorsal side.

9. The selectively positionable apparatus holder of claim 5, said at least one strip of loop material being attached near said proximal end of said at least one strap, and said at least one strip of hook material being attached near said distal end of said at least one strap.

10. The selectively positionable apparatus holder of claim 6, said at least one strip of loop material being attached near said proximal end of said at least one strap, and said at least one strip of hook material being attached near said distal end of said at least one strap.

11. The selectively positionable apparatus holder of claim 5, said at least one strap having further defined thereon a first plain section at said proximal end of said at least one strap, at least one strip of loop material attached upon said dorsal side near said proximal end of said at least one strap, a second plain section approximately midway between said proximal end and said distal end of said at least one strap, at least one strip of hook material attached upon said dorsal side near said distal end of said at least one strap, and a third plain section of strap terminating at the distal end of said at least one strap.

12. The selectively positionable apparatus holder of claim 6, said at least one strap having further defined thereon a first plain section at said proximal end of said at least one strap, at least one strip of loop material attached upon said dorsal side near said proximal end of said at least one strap, a second plain section approximately midway between said proximal end and said distal end of said at least one strap, at least one strip of hook material attached upon said dorsal side near said distal end of said at least one strap, and a third plain section of strap terminating at the distal end of said at least one strap.

13. The selectively positionable apparatus holder of claim 5, said at least one strip of loop material and at least one strip of hook material being low profile material.

14. The selectively positionable apparatus holder of claim 6, said at least one strip of loop material and at least one strip of hook material being low profile material.

15. The selectively positionable apparatus holder of claim 5, said base and said at least one strap integrally formed with said base being constructed out of a high-density polyethylene material.

16. The selectively positionable apparatus holder of claim 6, said base and said at least one strap integrally formed with said base being constructed out of a high-density polyethylene material.

17. A selectively positionable apparatus holder, comprising:
a base having a dorsal side and a ventral side, said ventral side further including an adhesive coating whereby to be fixedly attachable to a surface, said base having defined therethrough a slot, said base further having a means of releasable attachment upon said dorsal side;
at least one strap integrally formed with said base, said at least one strap having a dorsal side, a ventral side, a proximal end to said base and a distal end projecting outward from said base;
said at least one strap further having a means of releasable attachment attached upon said dorsal side of said at least one strap;
whereby said selectively positionable apparatus holder may be selectively positioned upon a material to provide for releasably securing an apparatus.

18. The selectively positionable apparatus holder of claim 17, said means of releasable attachment being hook and loop material.

19. The selectively positionable apparatus holder of claim 17, said base and said at least one strap integrally formed with said base being constructed out of a high-density polyethylene material.
